(19) United States
(12) Patent Application Publication
(10) Pub. No.: US 2026/0176712 A1
(43) Pub. Date: Jun. 25, 2026

(54) A WELDING AND HEAT TREATMENT METHOD FOR A STEEL RAIL WITH DEEP HARDENED LAYER AND A STEEL RAIL

(71) Applicants: PANGANG GROUP PANZHIHUA IRON & STEEL RESEARCH INSTITUTE CO., LTD., Panzhihua, SC (CN); CHENGDU ADVANCED METAL MATERIALS INDUSTRY TECHNOLOGY RESEARCH INSTITUTE CO., LTD., Chengdu, SC (CN)

(72) Inventors: Xin LU, Panzhihua (CN); Dadong LI, Panzhihua (CN); Wei BAI, Panzhihua (CN); Jie HUANG, Panzhihua (CN)

(73) Assignees: PANGANG GROUP PANZHIHUA IRON & STEEL, Panzhihua, SC (CN); CHENGDU ADVANCED METAL MATERIALS, Chengdu, SC (CN)

(21) Appl. No.: 18/834,595

(22) PCT Filed: May 29, 2024
(86) PCT No.: PCT/CN2024/096058

§ 371 Date: Jul. 30, 2024

(30) Foreign Application Priority Data
Sep. 7, 2023 (CN) 202311152998.2

(51) Int. Cl. C21D 9/50; B23K 11/04; B23K 101/26; B23K 103/04; C21D 9/04; C22C 38/04

(52) U.S. Cl. CPC C21D 9/50; B23K 11/04; C21D 9/04; C22C 38/04; B23K 2101/26; B23K 2103/04

(57) ABSTRACT

The invention discloses a welding and heat treatment method for a steel rail with deep hardened layer and a steel rail. The method comprises: performing a flash welding on the steel rail, comprising sequentially performing an electrical heating stage and a pressure upsetting stage; wherein the electrical heating stage has a voltage of 300-385V, an average current of 500-800 A, and a duration of 80-100 s; and performing a heat treatment on the flash-welded steel rail, comprising sequentially performing a first cooling stage, a heating stage, a second cooling stage, and a third cooling stage, wherein the first cooling stage has a termination temperature of 25-100° C., the heating stage has a termination temperature of 800-1100° C., the second cooling stage has an initial temperature greater than 900° C. and a termination temperature of 600-700° C., and the third cooling stage has an initial temperature of 600-700° C. and a termination temperature of 430-500° C. The invention can improve the internal hardness of the rail head of the flash welded joint of the steel rail, thereby improving the wear resistance and service life of the welded joint of the steel rail.

### TECHNICAL FIELD

The disclosure relates to the technical field of rail welding, in particular to a welding and heat treatment method for a steel rail with deep hardened layer and a steel rail.

### BACKGROUND OF THE DISCLOSURE

As the most important structural part of railway lines, steel rails are required to have higher performance in the service environment of heavy axle load and high frequency, which is mainly reflected in wear resistance and fatigue performance. Research shows that without considering other factors such as wheel-rail matching and wear media, the higher the hardness of the steel rail, the better its wear resistance. Therefore, the hardness value is usually used as one of the main indicators to measure the wear resistance of materials. The main methods to characterize the hardness of the steel rail base material are tread hardness and section hardness, and the methods to characterize the steel rail joints are mainly tread hardness and longitudinal section hardness.

Currently, mainstream welding method for the steel rails is flash welding. The method of the steel rail flash welding is: when the current passes through the small contact point on the contact surface of the steel rail end, the resistance at the contact point and the arc on the contact surface will generate heat to heat the rail end to be welded. Apply pressure to the joint after an appropriate amount of time so that the entire area of the steel rail butt surface is firmly bonded simultaneously. With the high degree of automation and stable welding quality, the flash welding is the main method for on-site construction and welding of seamless lines at home and abroad. According to production method, the flash welding is mainly divided into two types: fixed flash welding and mobile flash welding. For the fixed flash welding, the welding equipment is usually fixed in the factory building, so it is usually called factory welding or base welding. The method of fixed flash welding is usually to short-circuit the rail to use resistance heat to heat the steel rail, and the heating process is not (or a small amount of) accompanied by flash. At present, the most widely used mobile flash welding machines at home and abroad are K950 and YGH-1200TH mobile flash welding machines. The K950 mobile flash welding machine can ensure the high quality and long life of the welding machine head.

How to improve the hardness of steel rail flash welded joints to improve the wear resistance and fatigue performance of steel rails is an urgent technical problem in this field that needs to be solved.

### SUMMARY OF THE DISCLOSURE

The main purpose of the present disclosure is to provide a welding and heat treatment method for a steel rail with deep hardened layer and a steel rail, so as to solve the technical problem of how to improve the hardness of a steel rail flash welded joints.

According to one aspect of the present disclosure, a welding and heat treatment method for a steel rail with deep hardened layer is proposed, comprising:
performing a flash welding on the steel rail, comprising: sequentially performing an electrical heating stage and a pressure upsetting stage; wherein the electrical heating stage has a voltage of 300-385V, an average current of 500-800 A, and a duration of 80-100 s; and
performing a heat treatment on the flash-welded steel rail, comprising: sequentially performing a first cooling stage, a heating stage, a second cooling stage, and a third cooling stage, wherein the first cooling stage has a termination temperature of 25-100° C., the heating stage has a termination temperature of 800-1100° C., the second cooling stage has an initial temperature greater than 900° C. and a termination temperature of 600-700° C., and the third cooling stage has an initial temperature of 600-700° C. and a termination temperature of 430-500° C.

According to an embodiment of the present disclosure, the electrical heating stage has an opposing pressure of 20-130 kN applied to both ends of the steel rail to be welded, and a steel rail consumption of 8-20 mm.

According to an embodiment of the present disclosure, performing the flash welding on the steel rail further comprises: performing a knob pushing stage after the pressure upsetting stage, and it lasts for 5-10 s from end of the pressure upsetting stage to complete end of the knob pushing stage.

According to an embodiment of the present disclosure, throughout the flash welding, the steel rails on both sides in an area of 0˜25 mm from an end face of the steel rail to be welded has a temperature of 900-1650° C., and a duration of 100-200 s.

According to an embodiment of the present disclosure, the first cooling stage has an average cooling rate of 5-10° C./s.

According to an embodiment of the present disclosure, in the heating stage, heating is carried out at a top of a rail head, a side of the rail head and a lower jaw of the rail head of a near-weld area of a steel rail joint with an average heating rate of 2-30° C./s.

According to an embodiment of the present disclosure, in the second cooling stage, accelerated cooling is carried out at a top of a rail head with an average cooling rate of 25-40° C./s.

According to an embodiment of the present disclosure, in the third cooling stage: accelerated cooling is carried out at a top of a rail head, a side of the rail head and a lower jaw of the rail head, and the top of the rail head has an average cooling rate of 20-35° C./s, the side of the rail head and the lower jaw of the rail head has an average cooling rate of 5-15° C./s.

According to an embodiment of the present disclosure, the steel rail to be welded is a hardened pearlite steel rail with a high strength rail head, the steel rail comprises the following main chemical components: by mass fraction, C element of 0.74%-0.86%, Si element of 0.10%-0.60%, Mn element of 0.75%-1.25%, P element and S element no more than 0.020%, Cr element no more than 0.30%, and V element no more than 0.01%; and the steel rail has a tensile strength of at least 1172 MPa at a gauge corner and a hardness greater than or equal to 370 HB at a depth of 25 mm from an outer contour of a rail head.

According to another aspect of the disclosure, an internal area of a rail head in a near-weld area has a hardness of 95%-110% of that of the internal area of the rail head of a rail base material, and the internal area of the rail head in the near-weld area has a microstructure with a pearlite area ratio greater than or equal to 97%, wherein the internal area of the rail head is an area with a depth of 0-25 mm from a surface of the rail head.

In the welding and heat treatment method for a steel rail with deep hardened layer according to embodiments of the present disclosure, the internal hardness of the rail head of the flash welded joint can be improved by improving the relevant parameters (especially the voltage, current, time and other parameters of the electrical heating stage) of the flash welding process, and controlling the post-welding heat treatment process in fine stages and designing reasonable parameters, so as to improve the wear resistance and service life of the welded joint of the steel rail.

### BRIEF DESCRIPTION OF THE DRAWING

In order to more clearly state the technical scheme in the embodiment of the disclosure or the prior art, the following is a brief introduction of the drawings required to be used in the description of the embodiment or the prior art. It is obvious that the drawings described below are only some embodiments of the disclosure. On the premise of no creative labor, ordinary technicians in the field can obtain other drawings according to these drawings.

FIG. 1 shows a schematic diagram of the internal area of the rail head in near-weld area according to an embodiment of the present disclosure; and

FIG. 2 shows another schematic view of the internal area of the rail head in near-weld area according to an embodiment of the present disclosure.

### DETAILED DESCRIPTION OF THE PREFERRED EMBODIMENTS

In order to make the purpose, technical solutions and advantages of the present disclosure more clear, the embodiments of the present disclosure will be further described in detail below with reference to specific embodiments and the accompanying drawings.

It should be noted that all representations using “first” and “second” in embodiments of the disclosure are intended to distinguish between two non-identical entities or parameters with the same name. It can be seen that “first” and “second” are for the convenience of expression only, and should not be understood as a limitation of the embodiment of the disclosure, and subsequent embodiments will not be explained one by one.

The disclosure proposes a welding and heat treatment method for a steel rail with deep hardened layer, comprising:
performing a flash welding on the steel rail, comprising: sequentially performing an electrical heating stage and a pressure upsetting stage; wherein the electrical heating stage has a voltage of 300-385V, an average current of 500-800 A, and a duration of 80-100 s; and
performing a heat treatment on the flash-welded steel rail, comprising: sequentially performing a first cooling stage, a heating stage, a second cooling stage, and a third cooling stage, wherein the first cooling stage has a termination temperature of 25-100° C., the heating stage has a termination temperature of 800-1100° C., the second cooling stage has an initial temperature of greater than 900° C. and a termination temperature of 600-700° C., and the third cooling stage has an initial temperature of 600-700° C. and a termination temperature of 430-500° C.

In embodiments of the present disclosure, the internal hardness of the rail head of the flash welded joint can be improved by improving the relevant parameters (especially the voltage, current, time and other parameters of the electrical heating stage) of the flash welding process, and controlling the post-welding heat treatment process in fine stages and designing reasonable parameters, so as to improve the wear resistance and service life of the welded joint of the steel rail, wherein, the internal hardness of the rail head of the welded joint can refer to the hardness of the internal area of the rail head in near-weld area described below.

In some embodiments, the steel rail to be welded is a hardened pearlite steel rail with a high strength rail head, the steel rail comprises the following main chemical components: by mass fraction, C element of 0.74%-0.86%, Si element of 0.10%-0.60%, Mn element of 0.75%-1.25%, P element and S element no more than 0.020%, Cr element no more than 0.30%, and V element no more than 0.01%; and the steel rail has a tensile strength of at least 1172 MPa at the 12.7 mm gauge angle from a tread of the rail head and a side of the rail head, and a hardness greater than or equal to 370 HB at a depth of 25 mm from an outer contour of the rail head. In the prior art, the flash welded joint for hardened pearlite rail with high strength rail head has the defects of low wear resistance and short service life. The present disclosure provides a welding and heat treatment method for a steel rail with deep hardened layer to solve this problem.

In the embodiment of the present disclosure, by setting the voltage, current, and time values as described above, during the electrical heating stage, the steel rail to be welded is subjected to short-circuit contact in the energized state and is heated by the resistance heat generated by the short circuit contact and the heat generated by the lintel blasting of a small amount of lintel formed between the liquid metal on the end of the steel rail to be welded.

In some embodiments, the electrical heating stage has a opposing pressure of 20-130 kN applied to both ends of the steel rail to be welded, and a rail consumption of 8-20 mm, so as to maintain the state of intermittent short circuit and lintel blasting.

In some embodiments, performing the flash welding on the steel rail further comprises: performing a knob pushing stage after the pressure upsetting stage. The knob pushing can make weld surface forming beautiful and improve welding quality. An integrated profiled rail knob pushing mechanism can be used for the knob pushing. In some embodiments, it lasts for 5-10 s from the end of the pressure upsetting stage to the complete end of the knob pushing stage, thereby ensuring the quality of the welded joint and the effect of subsequent post-weld heat treatment.

In some embodiments, the flash welding process mainly comprises four stages: an electrode clamping, the electrical heating stage, the pressure upsetting stage, and a rapid knob pushing stage. During the entire flash welding process, the steel rails on both sides in an area of 0˜25 mm from an end face of the steel rail to be welded has a temperature of 900-1650° C., and a duration of 100-200 s.

In the embodiment of the present disclosure, the post-weld heat treatment process mainly includes four stages: the first cooling stage, the heating stage, the second cooling stage, and the third cooling stage. After the end of the previous stage, the next stage is entered. The initial temperature and/or the termination temperature of each stage are defined above.

In some embodiments, the first cooling stage has an average cooling rate of 5-10° C./s.

In some embodiments, in the heating stage, heating is carried out at a top of a rail head, a side of the rail head and a lower jaw of the rail head of a near-weld area of a steel rail joint with an average heating rate of 2-30° C./s.

In some embodiments, in the second cooling stage, accelerated cooling is carried out at a top of a rail head with an average cooling rate of 25-40° C./s.

In some embodiments, in the third cooling stage: accelerated cooling is carried out at a top of a rail head, a side of the rail head and a lower jaw of the rail head, and the top of the rail head has an average cooling rate of 20-35° C./s, the side of the rail head and the lower jaw of the rail head has an average cooling rate of 5-15° C./s.

The main function of heat treatment is to eliminate the internal stress of the welded joint, refine the austenite grains, homogenize the structure, and improve the strength and hardness of the joint. In addition to the basic function of the heat treatment, the main function of the heat treatment method in the disclosure is to improve the internal hardness of the rail head of the flash welded joint of the rail with a deep hardening layer. The initial temperature of the first cooling stage of the heat treatment process is the temperature at the end of the welding process. Since the thickness of each area of the rail section is different, the rate of each area is different under natural cooling conditions. In order to prevent the joint from martensite, bainite and other structural phase transformations during the cooling process of the first cooling stage, it is necessary to control the cooling rate of the first cooling stage to 5-10° C./s; the cooling termination temperature of the first cooling stage is controlled at 25-100° C. to ensure that the surface and core of the rail joint are all transformed into pearlite. The main function of the heating stage is to re-transform the joint area that has completely undergone pearlite transformation into austenite when cooled to 25-100° C. In order to ensure that the temperature inside the joint, outside the joint and the area of the whole section is uniform, it is necessary to control the temperature rise rate of 2-30° C./s in the heating stage. The functions of the second cooling stage after the end of the heating stage comprise rapidly cooling the tread area of the rail head, increasing the degree of supercooling during the cooling process, and enhancing the driving force of the transformation from austenite to low temperature structure. Therefore, it must be controlled the cooling rate in the second cooling stage is an average cooling rate of 25-40° C./s, and the termination temperature of rapid cooling in the second cooling stage is required to be the initial temperature of the transformation of austenite to a low-temperature structure. Therefore, in order to achieve the above effect, the initial temperature of the second cooling stage must be controlled to be greater than 900° C. and the termination temperature is 600-700° C. The main function of the third cooling stage is to transform all the supercooled austenite structure into pearlite structure to achieve the purpose of refining the austenite grains and the spacing between pearlite lamellae. At the same time, in order to refine the core structure of the rail head far away from the tread and improve the hardness, it is necessary to increase the cooling intensity at the side of the rail head and the lower jaw of the rail head at the same time. Therefore, it is necessary to accelerate the cooling of the top of the rail head, the side of the rail head and the lower jaw of the rail head. After the second cooling stage, the joint temperature on the top of the rail head has been reduced to a lower range. With the supplementary cooling of the side of the rail head and the lower jaw of the rail head, the air cooling intensity on the top of the rail head can be appropriately reduced to avoid the occurrence of martensite, bainite and other harmful phase transformation processes. Therefore it is necessary to control the average cooling rate on the top of the rail head to 20-35° C./s, the average cooling rate on the side of the rail head and the lower jaw of the rail head to 5-15° C./s, and the terminate temperature is 430-500° C.

The temperature of rail joints and the rate of cooling/heating directly affect the phase change process of metal materials. All heating temperatures, cooling/heating rate and cooling termination temperatures in the above process defined by the present disclosure work together to achieve the heat treatment effect as described above.

The present disclosure also proposes a steel rail prepared by the above method. Through the above method, an internal area of a rail head in a near-weld area has a hardness of 95%-110% of that of the internal area of the rail head of a rail base material, and the internal area of the rail head in the near-weld area has a microstructure with a pearlite area ratio greater than or equal to 97%, wherein the internal area of the rail head is an area with a depth of 0-25 mm from a surface of the rail head.

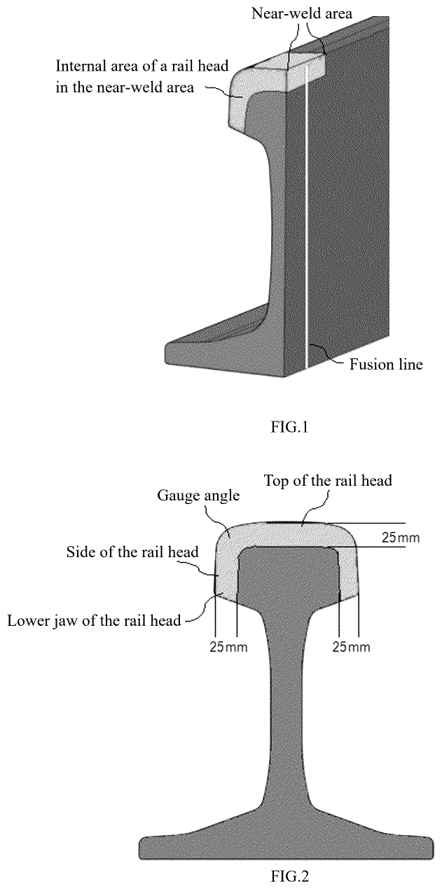

Referring to FIGS. 1 and 2, the near-weld area (also called a near-fusion line area) can be a heat-affected area 1-10 mm from each side of the fusion line; the internal area of the rail head can be an area with a depth of 0-25 mm from the surface of the rail head, specifically comprising: the top of the rail head, the rail gauge angle, both sides of the rail head, and the area at the lower jaw of the rail head with a depth of 0-25 mm from the outer surface of the rail head)

In summary, aiming at the technical problems of low wear resistance and short service life of flash welding head of high-strength rail hardened pearlite rail, the disclosure provides a welding and heat treatment method for a steel rail with deep hardened layer, which comprises two main processes of welding and post-welding heat treatment. By improving the parameters and steps of the two main processes, the disclosure can greatly improve the hardness of the high-strength rail head hardened pearlite rail flash welded joint, thereby improving the wear resistance and service life.

Description will be made below based on specific examples and comparative examples.

### EXAMPLE 1

In this embodiment, the steel rail comprises the following main chemical components: by mass fraction, C element of 0.76%, Si element of 0.55%, Mn element of 1.15%, P element and S element no more than 0.020%, Cr element no more than 0.30%, and V element no more than 0.01%. The minimum tensile strength at the 12.7 mm gauge angle from a tread of the rail head and a side of the rail head is 1252 MPa, and the hardness at a depth of 25 mm from the rail head outer surface is ≥375 HB. There are two main processes: welding and post-weld heat treatment. The welding method is rail flash welding, and the welding process mainly comprises four stages: electrode clamping, electrical heating, pressure upsetting, and rapid knob pushing. During the entire flash welding process, the temperature of the steel rails on both sides in the area of 0˜25 mm from the end face of the steel rail to be welded is 900-1650° C., and the duration is 130 s. During the heating stage of the welding process, the steel rail to be welded is heated by short circuit contact in the energized state. Specifically, the resistance heat generated by the short circuit contact and the heat generated by the lintel blasting of a small amount of lintel formed between the liquid metal on the end of the steel rail to be welded are used to heat the steel rail. The voltage in the heating stage is 300V, the average current is 500 A, and the duration is 100 s; during the heating stage, the opposing pressure applied to both ends of the steel rail to be welded is 130 kN, and the rail consumption is 15 mm. An integrated profiled rail knob pushing mechanism can be used for rapid knob pushing stage during the welding process. In order to ensure the quality of the joint and the effect of subsequent post-weld heat treatment, the time from the end of upsetting to the complete completion of knob pushing is 10 s. The post-weld heat treatment is performed after welding. The post-weld heat treatment mainly comprises four stages: a first cooling stage, a heating stage, a second cooling stage, and a third cooling stage. After the previous stage is completed, the next stage is entered. The average cooling rate in the first cooling stage of the post-weld heat treatment process is 8° C./s, and the termination temperature of cooling is 50° C.; in the heating stage of the post-weld heat treatment process, special equipment is used to heating is carried out on the top, side and the lower jaw of the rail head in near-weld area. The average temperature rise rate of the heating process is 13° C./s, and the termination temperature of the heating stage is 1000° C. In the second cooling stage of the post-weld heat treatment process, special equipment is used to accelerate the cooling of the top of the rail head, the initial temperature of accelerated cooling is >900° C., the average cooling rate during accelerated cooling of the rail head is 35° C./s, and the termination temperature of accelerated cooling is 700° C.; in the third cooling stage of the post-weld heat treatment process, special equipment is used to perform accelerated cooling on the top of the rail head, the sides of the rail head, and the lower jaw of the rail head. The initial temperature of accelerated cooling is 700° C. The average cooling rate during accelerated cooling of the top of the rail head is 35° C./s. The average cooling rate of the side of the rail head and the lower jaw of the rail head under accelerated cooling is 15° C./s, and the termination temperature of accelerated cooling is 500° C. The longitudinal hardness of 5 mm and 25 mm under the tread of the joint was tested according to AS1085.20, and the microstructure of the joint was tested according to BS EN14587. The results show that for the high-strength rail head hardened pearlite rail flash welding joint formed by this method, the ratio of the internal hardness of the rail head in near-fusion line to the hardness of the rail base material at the same position is 98%, and the area ratio of microstructure pearlite is ≥98%.

### EXAMPLE 2

In this embodiment, the steel rail comprises the following main chemical components: by mass fraction, C element of 0.86%, Si element of 0.10%, Mn element of 0.75%, P element and S element no more than 0.020%, Cr element no more than 0.30%, and V element no more than 0.01%. The minimum tensile strength at the 12.7 mm gauge angle from a tread of the rail head and a side of the rail head is 1183 MPa, and the hardness at a depth of 25 mm from the rail head outer surface is ≥380 HB. There are two main processes: welding and post-weld heat treatment. The welding method is rail flash welding, and the welding process mainly comprises four stages: electrode clamping, electrical heating, pressure upsetting, and rapid knob pushing. During the entire flash welding process, the temperature of the steel rails on both sides in the area of 0˜25 mm from the end face of the steel rail to be welded is 900-1650° C., and the duration is 200 s. During the heating stage of the welding process, the steel rail to be welded is heated by short circuit contact in the energized state. Specifically, the resistance heat generated by the short circuit contact and the heat generated by the lintel blasting of a small amount of lintel formed between the liquid metal on the end of the steel rail to be welded are used to heat the steel rail. The voltage in the heating stage is 385V, the average current is 800 A, and the duration is 100 s; during the heating stage, he opposing pressure applied to both ends of the steel rail to be welded is 20 kN, and the rail consumption is 20 mm. An integrated profiled rail knob pushing mechanism can be used for rapid knob pushing stage during the welding process. In order to ensure the quality of the joint and the effect of subsequent post-weld heat treatment, the time from the end of upsetting to the complete completion of knob pushing is 10 s. The post-weld heat treatment is performed after welding. The post-weld heat treatment mainly comprises four stages: a first cooling stage, a heating stage, a second cooling stage, and a third cooling stage. After the previous stage is completed, the next stage is entered. The average cooling rate in the first cooling stage of the post-weld heat treatment process is 10° C./s, and the termination temperature of cooling is 100° C.; in the heating stage of the post-weld heat treatment process, special equipment is used to perform heating on the top, side and the lower jaw of the rail head in near-weld area. The average temperature rise rate of the heating process is 30° C./s, and the termination temperature of the heating stage is 900° C.

In the second cooling stage of the post-weld heat treatment process, special equipment is used to perform accelerated cooling on the top of the rail head, the initial temperature of accelerated cooling is >900° C., the average cooling rate during accelerated cooling of the rail head is 40° C./s, and the termination temperature of accelerated cooling is 600° C.; in the third cooling stage of the post-weld heat treatment process, special equipment is used to perform accelerated cooling on the top of the rail head, the sides of the rail head, and the lower jaw of the rail head. The initial temperature of accelerated cooling is 600° C. The average cooling rate during accelerated cooling of the top of the rail head is 20° C./s. The average cooling rate of the side of the rail head and the lower jaw of the rail head under accelerated cooling is 5° C./s, and the termination temperature of accelerated cooling is 430° C. The longitudinal hardness of 5 mm and 25 mm under the tread of the joint was tested according to AS1085.20, and the microstructure of the joint was tested according to BS EN14587.The results show that for the high-strength rail head hardened pearlite rail flash welding joint formed by this method, the ratio of the internal hardness of the rail head in near-fusion line to the hardness of the rail base material at the same position is 99%, and the area ratio of microstructure pearlite is ≥98%.

### EXAMPLE 3

In this embodiment, the steel rail comprises the following main chemical components: by mass fraction, C element of 0.80%, Si element of 0.50%, Mn element of 1.20%, P element and S element no more than 0.020%, Cr element no more than 0.30%, and V element no more than 0.01%. The minimum tensile strength at the 12.7 mm gauge angle from a tread of the rail head and a side of the rail head is 1302 MPa, and the hardness at a depth of 25 mm from the rail head outer surface is ≥389 HB. There are two main processes: welding and post-weld heat treatment. The welding method is rail flash welding, and the welding process mainly comprises four stages: electrode clamping, electrical heating, pressure upsetting, and rapid knob pushing. During the entire flash welding process, the temperature of the steel rails on both sides in the area of 0˜25 mm from the end face of the steel rail to be welded is 900-1650° C., and the duration is 150 s. During the heating stage of the welding process, the steel rail to be welded is heated by short circuit contact in the energized state. Specifically, the resistance heat generated by the short circuit contact and the heat generated by the lintel blasting of a small amount of lintel formed between the liquid metal on the end of the steel rail to be welded are used to heat the steel rail. The voltage in the heating stage is 375V, the average current is 600 A, and the duration is 90 s; during the heating stage, the opposing pressure applied to both ends of the steel rail to be welded is 100 kN, and the rail consumption is 13 mm. An integrated profiled rail knob pushing mechanism can be used for rapid knob pushing stage during the welding process. In order to ensure the quality of the joint and the effect of subsequent post-weld heat treatment, the time from the end of upsetting to the complete completion of knob pushing is 8 s. The post-weld heat treatment is performed after welding. The post-weld heat treatment mainly comprises four stages: a first cooling stage, a heating stage, a second cooling stage, and a third cooling stage. After the previous stage is completed, the next stage is entered. The average cooling rate in the first cooling stage of the post-weld heat treatment process is 8° C./s, and the termination temperature of cooling is 75 C; in the heating stage of the post-weld heat treatment process, special equipment is used to perform heating on the top, side and the lower jaw of the rail head in near-weld area. The average temperature rise rate of the heating process is 15° C./s, and the termination temperature of the heating stage is 1100° C. In the second cooling stage of the post-weld heat treatment process, special equipment is used to perform accelerated cooling on the top of the rail head, the initial temperature of accelerated cooling is >900° C., the average cooling rate during accelerated cooling of the rail head is 30° C./s, and the termination temperature of accelerated cooling is 650° C.; in the third cooling stage of the post-weld heat treatment process, special equipment is used to perform accelerated cooling on the top of the rail head, the sides of the rail head, and the lower jaw of the rail head. The initial temperature of accelerated cooling is 650° C. The average cooling rate during accelerated cooling of the top of the rail head is 30° C./s. The average cooling rate of the side of the rail head and the lower jaw of the rail head under accelerated cooling is 12° C./s, and the termination temperature of accelerated cooling is 460° C. The longitudinal hardness of 5 mm and 25 mm under the tread of the joint was tested according to AS1085.20, and the microstructure of the joint was tested according to BS EN14587. The results show that for the high-strength rail head hardened pearlite rail flash welding joint formed by this method, the ratio of the internal hardness of the rail head in near-fusion line to the hardness of the rail base material at the same position is 98%, and the area ratio of microstructure pearlite is ≥99%.

### COMPARATIVE EXAMPLE 1

In this comparative embodiment, the steel rail comprises the following main chemical components: by mass fraction, C element of 0.81%, Si element of 0.56%, Mn element of 0.90%, P element and S element no more than 0.020%, Cr element no more than 0.30%, and V element no more than 0.01%. The minimum tensile strength at the 12.7 mm gauge angle from a tread of the rail head and a side of the rail head is 1272 MPa, and the hardness at a depth of 25 mm from the rail head outer surface is ≥380 HB. There are two main processes: welding and post-weld heat treatment. The welding method is rail flash welding, and the welding process mainly comprises four stages: electrode clamping, electrical heating, pressure upsetting, and rapid knob pushing. During the entire flash welding process, the temperature of the steel rails on both sides in the area of 0˜25 mm from the end face of the steel rail to be welded is 900-1650° C., and a duration is 250 s. During the heating stage of the welding process, the steel rail to be welded is heated by short circuit contact in the energized state. Specifically, the resistance heat generated by the short circuit contact and the heat generated by the lintel blasting of a small amount of lintel formed between the liquid metal on the end of the steel rail to be welded are used to heat the steel rail. The voltage in the heating stage is 390V, the average current is 900 A, and the duration is 150 s; during the heating stage, the opposing pressure applied to both ends of the steel rail to be welded is 10 kN, and the rail consumption is 25 mm. An integrated profiled rail knob pushing mechanism can be used for rapid knob pushing stage during the welding process. In order to ensure the quality of the joint and the effect of subsequent post-weld heat treatment, the time from the end of upsetting to the complete completion of knob pushing is 20 s. The post-weld heat treatment is performed after welding. The post-weld heat treatment mainly comprises four stages: a first cooling stage, a heating stage, a second cooling stage, and a third cooling stage. After the previous stage is completed, the next stage is entered. The average cooling rate in the first cooling stage of the post-weld heat treatment process is 2° C./s, and the termination temperature of cooling is 200° C.; in the heating stage of the post-weld heat treatment process, special equipment is used to perform heating on the top, side and the lower jaw of the rail head in near-weld area. The average temperature rise rate of the heating process is 35° C./s, and the termination temperature of the heating stage is 800° C. In the second cooling stage of the post-weld heat treatment process, special equipment is used to perform accelerated cooling on the top of the rail head, the initial temperature of accelerated cooling is >900° C., the average cooling rate during accelerated cooling of the rail head is 20° C./s, and the termination temperature of accelerated cooling is 500° C.; in the third cooling stage of the post-weld heat treatment process, special equipment is used to perform accelerated cooling on the top of the rail head, the sides of the rail head, and the lower jaw of the rail head. The initial temperature of accelerated cooling is 500° C. The average cooling rate during accelerated cooling of the top of the rail head is 15° C./s. The average cooling rate of the side of the rail head and the lower jaw of the rail head under accelerated cooling is 2° C./s, and the termination temperature of accelerated cooling is 550° C. The longitudinal hardness of 5 mm and 25 mm under the tread of the joint was tested according to AS1085.20, and the microstructure of the joint was tested according to BS EN14587. The results show that for the high-strength rail head hardened pearlite rail flash welding joint formed by this method, the ratio of the internal hardness of the rail head in near-fusion line to the hardness of the rail base material at the same position is 85%, and the area ratio of microstructure pearlite is ≥96%, the joint has obvious low collapse, which does not meet the requirements.

### COMPARATIVE EXAMPLE 2

In this comparative embodiment, the steel rail comprises the following main chemical components: by mass fraction: C element of 0.84%, Si element of 0.60%, Mn element of 1.15%, P element and S element no more than 0.020%, Cr element no more than 0.30%, and V element no more than 0.01%. The minimum tensile strength at the 12.7 mm gauge angle from a tread of the rail head and a side of the rail head is 1293 MPa, and the hardness at a depth of 25 mm from the rail head outer surface is ≥390 HB. There are two main processes: welding and post-weld heat treatment. The welding method is rail flash welding, and the welding process mainly comprises four stages: electrode clamping, electrical heating, pressure upsetting, and rapid knob pushing. During the entire flash welding process, the temperature of the steel rails on both sides in the area of 0˜25 mm from the end face of the steel rail to be welded is 900-1650° C., and a duration is 90 s. During the heating stage of the welding process, the steel rail to be welded is heated by short circuit contact in the energized state. Specifically, the resistance heat generated by the short circuit contact and the heat generated by the lintel blasting of a small amount of lintel formed between the liquid metal on the end of the steel rail to be welded are used to heat the steel rail. The voltage in the heating stage is 300V, the average current is 450 A, and the duration is 70 s; during the heating stage, the opposing pressure applied to both ends of the steel rail to be welded is 140 kN, and the rail consumption is 8-20 mm. An integrated profiled rail knob pushing mechanism can be used for rapid knob pushing stage during the welding process. In order to ensure the quality of the joint and the effect of subsequent post-weld heat treatment, the time from the end of upsetting to the complete completion of knob pushing is 3 s. The post-weld heat treatment is performed after welding. The post-weld heat treatment mainly comprises four stages: a first cooling stage, a heating stage, a second cooling stage, and a third cooling stage. After the previous stage is completed, the next stage is entered. The average cooling rate in the first cooling stage of the post-weld heat treatment process is 60° C./s, and the termination temperature of cooling is 20° C.; in the heating stage of the post-weld heat treatment process, special equipment is used to perform heating on the top, side and the lower jaw of the rail head in near-weld area. The average temperature rise rate of the heating process is 1° C./s, and the termination temperature of the heating stage is 1200° C. In the second cooling stage of the post-weld heat treatment process, special equipment is used to perform accelerated cooling on the top of the rail head, the initial temperature of accelerated cooling is >900° C., the average cooling rate during accelerated cooling of the rail head is 50° C./s, and the termination temperature of accelerated cooling is 750° C.; in the third cooling stage of the post-weld heat treatment process, special equipment is used to perform accelerated cooling on the top of the rail head, the sides of the rail head, and the lower jaw of the rail head. The initial temperature of accelerated cooling is 750° C. The average cooling rate during accelerated cooling of the top of the rail head is 40° C./s. The average cooling rate of the side of the rail head and the lower jaw of the rail head under accelerated cooling is 25° C./s, and the termination temperature of accelerated cooling is 400° C. The longitudinal hardness of 5 mm and 25 mm under the tread of the joint was tested according to AS1085.20, and the microstructure of the joint was tested according to BS EN14587. The results show that for the high-strength rail head hardened pearlite rail flash welding joint formed by this method, the ratio of the internal hardness of the rail head in near-fusion line to the hardness of the rail base material at the same position is 130%, and the area ratio of microstructure pearlite is ≥90%, abnormal martensitic tissue appeared in the joint, which did not meet the requirements.

Those of ordinary skill in the art should understand that the above discussion of any embodiments is only illustrative, and is not intended to imply that the scope of the disclosure of the embodiments of the present disclosure (including the claims) is limited to these examples; under the thinking of the embodiments of the present disclosure, the above embodiments or technical features in different embodiments can also be combined, and there are many other changes in different aspects of the embodiments of the present disclosure as described above, which are not provided in details for the sake of simplicity. Therefore, any omission, modification, equivalent substitution, improvement, etc. made within the spirit and principles of the embodiment of the disclosure shall be included in the scope of protection of the embodiment of the disclosure.

1. A welding and heat treatment method for a steel rail with deep hardened layer, characterized by comprising:
performing a flash welding on the steel rail, comprising: sequentially performing an electrical heating stage and a pressure upsetting stage; wherein the electrical heating stage has a voltage of 300-385V, an average current of 500-800 A, and a duration of 80-100 s; and
performing a heat treatment on the flash-welded steel rail, comprising: sequentially performing a first cooling stage, a heating stage, a second cooling stage, and a third cooling stage, wherein the first cooling stage has a termination temperature of 25-100° C., the heating stage has a termination temperature of 800-1100° C., the second cooling stage has an initial temperature greater than 900° C. and a termination temperature of 600-700° C., and the third cooling stage has an initial temperature of 600-700° C. and a termination temperature of 430-500° C.

2. The method according to claim 1, characterized in that, the electrical heating stage has an opposing pressure of 20-130 kN applied to both ends of the steel rail to be welded, and a steel rail consumption of 8-20 mm.

3. The method according to claim 1, characterized in that, performing the flash welding on the steel rail further comprises: performing a knob pushing stage after the pressure upsetting stage, and it lasts for 5-10 s from end of the pressure upsetting stage to complete end of the knob pushing stage.

4. The method according to claim 1, characterized in that, throughout the flash welding, the steel rails on both sides in an area of 0˜25 mm from an end face of the steel rail to be welded has a temperature of 900-1650° C., and a duration of 100-200 s.

5. The method according to claim 1, characterized in that, the first cooling stage has an average cooling rate of 5-10° C./s.

6. The method according to claim 1, characterized in that, in the heating stage, heating is carried out at a top of a rail head, a side of the rail head and a lower jaw of the rail head of a near-weld area of a steel rail joint with an average heating rate of 2-30° C./s.

7. The method according to claim 1, characterized in that, in the second cooling stage, accelerated cooling is carried out at a top of a rail head with an average cooling rate of 25-40° C./s.

8. The method according to claim 1, characterized in that, in the third cooling stage:
accelerated cooling is carried out at a top of a rail head, a side of the rail head and a lower jaw of the rail head, and the top of the rail head has an average cooling rate of 20-35° C./s, the side of the rail head and the lower jaw of the rail head has an average cooling rate of 5-15° C./s.

9. The method according to claim 1, characterized in that, the steel rail to be welded is a hardened pearlite steel rail with a high strength rail head, the steel rail comprises the following main chemical components: by mass fraction, C element of 0.74%-0.86%, Si element of 0.10%-0.60%, Mn element of 0.75%-1.25%, P element and S element no more than 0.020%, Cr element no more than 0.30%, and V element no more than 0.01%; and the steel rail has a tensile strength of at least 1172 MPa at a gauge corner and a hardness greater than or equal to 370 HB at a depth of 25 mm from an outer contour of a rail head.

10. A steel rail prepared by the method according to any one of claims 1 to 9, characterized in that, an internal area of a rail head in a near-weld area has a hardness of 95%-110% of that of the internal area of the rail head of a rail base material, and the internal area of the rail head in the near-weld area has a microstructure with a pearlite area ratio greater than or equal to 97%, wherein the internal area of the rail head is an area with a depth of 0-25 mm from a surface of the rail head.
